(19) United States
(12) Patent Application Publication
(10) Pub. No.: US 2009/0094386 A1
(43) Pub. Date: Apr. 9, 2009

(54) DISPLAY, COMPUTER SYSTEM AND METHOD FOR CONTROLLING A COMPUTER TO FALL ASLEEP

(75) Inventors: Wen-Wu Wang, Shenzhen City (CN); Yu-Zhang Wen, Shenzhen City (CN); Shih-Fang Wong, Tu-Cheng (TW); Tsung-Jen Chuang, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/195,383

(22) Filed: Aug. 20, 2008

(30) Foreign Application Priority Data
Oct. 9, 2007 (CN) 200710201965.7

(51) Int. Cl. G06F 13/12

(52) U.S. Cl. 710/10

(57) ABSTRACT

A display includes a power switch, a serial bus interface, a microprocessor and other necessary components. The serial bus interface is configured to connect to a serial bus interface of a computer through a data cable. The power switch is provided to be pressed down by user, which is used to turn on or off the display. The microprocessor determines whether the duration of pressing on the power switch exceeds a predetermined period of time. If yes, the microprocessor further determines a current state of the display. If the display is “off”, the microprocessor transmits a sleep control instruction to the computer and controls the computer to fall asleep. If the display is “on”, the microprocessor transmits a wake-up instruction to the computer and wakes up the computer. A method of controlling a computer to fall asleep is also provided.

### BACKGROUND

1. Technical Field

The present invention relates to displays and computer systems, as well as to methods for controlling the computer to fall asleep.

2. General Background

Nowadays, computers are increasingly popular partly due to the convenience they bring to our lives. However, computers consume a lot of power. As a result, there is a need to reduce the power consumption of the computers for environmental reasons, among others.

When computers are not being used and left on, power is wasted. A conventional method to address this issue uses software to control an “on” computer to fall asleep automatically when the computer has been idle for a predetermined period of time. However, power is still being wasted when the computer is idle before it falls asleep. Another conventional method for controlling an “on” computer to fall asleep is to provide a hot key on the keyboard. When the hot key has been pressed, it signals the computer to fall asleep. However, to further prevent wasting of power, computer users are also burdened with the inconvenience of having to manually shut down their display monitors.

As a result, it is necessary to provide a display and method to overcome the above-identified deficiencies.

### SUMMARY

The present invention provides a display capable of controlling a computer to fall asleep and a method thereof. According to the present invention, when shutting down the display, the computer is also controlled to fall asleep simultaneously.

A display includes a serial bus interface, a power switch, and a microprocessor. The serial bus interface is configured for connecting the display to a computer. The power switch is configured for producing a pressing signal when it has been pressed down. The microprocessor is configured for receiving the pressing signal, subsequently controlling the display to turn on or off.

The microprocessor further includes a pressing time detection module and a sleep control module. The pressing time detection module is configured for determining a duration of pressing on the power switch and outputting a trigger signal when the duration is longer than a predetermined period time. The sleep control module is configured for receiving the trigger signal, determining a current state of the display, and transmitting a sleep control instruction to the computer via the serial bus interface to control the computer to fall asleep when the current state of the display is “off”. Conversely, the sleep control module will transmit a wake-up instruction to the computer via the serial bus interface to wake up the computer from the sleep when the current state of the display is “on”.

A method for controlling a computer to fall asleep is also provided.

Other advantages and novel features will become more apparent from the following detailed description of embodiments when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present display. Moreover, in the drawings, like reference numerals designate corresponding parts throughout the several views.

FIG. 1 is a schematic, isometric view of a computer system according to an exemplary embodiment of the present invention.

FIG. 2 is a block diagram of a display of the computer system of FIG. 1 according to a first embodiment of the present invention.

FIG. 3 is a block diagram of a display of the computer system of FIG. 1 according to a second embodiment of the present invention.

FIG. 4 is a flowchart illustrating a method for controlling a computer to fall asleep in accordance with another exemplary embodiment of the present invention.

### DETAILED DESCRIPTION OF THE EMBODIMENTS

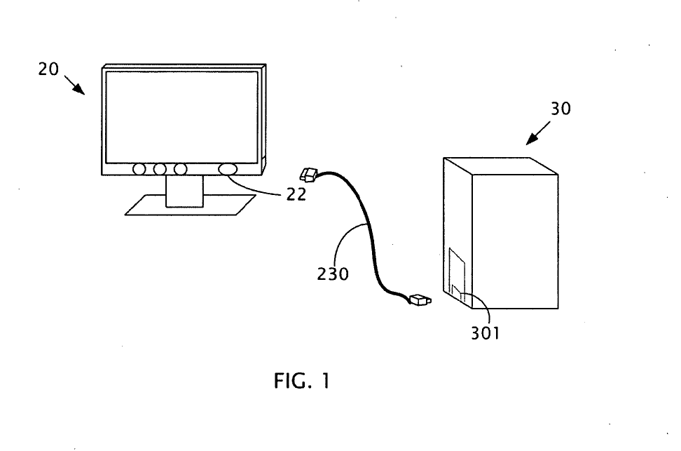

Referring to FIG. 1, the computer system includes a display 20 and a computer 30. The display 20 includes a power switch 22 and a serial bus interface (not shown) that is provided to connect to a serial bus interface 301 of the computer 30 via a data cable 230. The data cable 230 has a connector (not labeled) at each end. When the power switch 22 is pressed down by a user to shut down the display 20, if the pressing is held for a predetermined period of time, the display 20 transmits a sleep control instruction to the computer 30 via the data cable 230 and controls the computer 30 to fall asleep simultaneously. Likewise, when the power key 22 is pressed down by the user to turn on the display 20, and the pressing is held for the predetermined period of time, the display 20 transmits a wake-up instruction to the computer 30 via the data cable 230, thereby waking up the computer 30 from its sleeping mode.

The computer 30 further includes a sleep detection module (not shown) to detect the sleep control instruction and the wake-up instruction and, accordingly, controls the computer 30 to fall asleep or wake up from the sleep when receiving either of the two instructions. If a duration of pressing on the power switch 22 is not longer than the predetermined period time, the display 20 will only turn itself off without outputting any additional instructions to the computer 30.

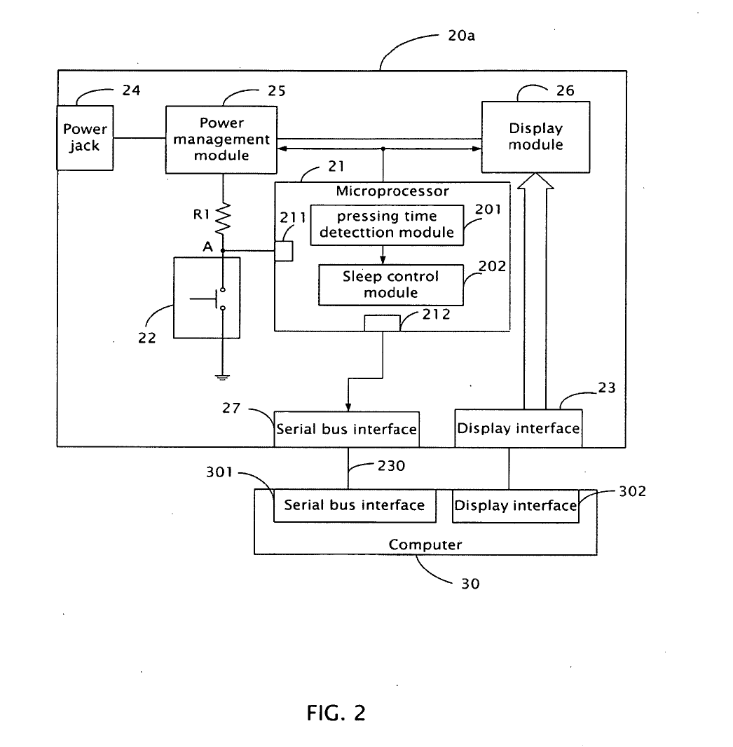

Referring also to FIG. 2, in a first embodiment, the display 20 is a liquid crystal display (LCD) 20a. The LCD 20a includes a microprocessor 21, a power switch 22, a display interface 23, a power jack 24, a power management module 25, a display module 26, and a serial bus interface 27. The serial bus interface 27 can be a universal serial bus (USB) interface or an IEEE 1 394 interface. The display interface 23 can be a video graphics array (VGA) interface, a digital video interface (DVI), a USB interface, or an IEEE 1394 interface. The serial bus interface 27 is configured for connecting to the serial bus interface 301 of the computer 30 via the data cable 230, while the display interface 23 is configured for connecting to a display interface 302 of the computer 30.

The microprocessor 21 includes a signal input port 211, a plurality of control ports (not shown), a pressing time detection module 201, a sleep control module 202, and an output port 212 that is connected to the serial bus interface 27. The microprocessor 21 can transmit control signals to the power management module 25 and the display module 26 via the control ports. The power management module 25 distributes power from the power jack 24 to a plurality of functional modules, including the display module 26 and the microprocessor 21. The power switch 22 and a resistor RI are connected between an output port (not shown) of the power management module 25 and ground via a serial cable. A connection node A of the power switch 22 and the resistor R1 are connected to the signal input port 211.

Assuming the power switch 22 hasn't been pressed down by a user, it is in a switched-off state. The signal input port 211 obtains a logic high signal from the output port of the power management module 25 through the resistor RI. The LCD 20a maintains its original “on” or “off” state.

When the power switch 22 is pressed down by the user, the signal input port 211 obtains a logic low signal (hereinafter referred to as a “pressing signal”) by connecting to the ground through the power switch 22. The microprocessor 21 accordingly controls the LCD 20a to modify the state from a first state to a second state. For example, if the first state is “on”, then the second state is “off”, and vice versa. Namely, if the LCD 20a was originally “on”, the microprocessor 21 controls the power management module 25 to discontinue the power to the display module 26 via the control port when the power switch 22 is pressed down, thus shutting down the LCD 20a and changing the LCD 20a to the “off” state. If the first state of the LCD 20a was originally “off”, the microprocessor 21 controls the power management module 25 to distribute the power to the display module 26 when the power switch 22 is pressed down, thereby turning on the LCD 20a and changing the LCD 20a to the “on” state.

The pressing time detection module 201 detects a duration of pressing on the power switch 22 and determines whether the duration longer than a predetermined period of time (e.g., 2 seconds) or not. If the duration is longer than the predetermined period of time, the pressing time detection module 201 produces a trigger signal and transmits the trigger signal to the sleep control module 202.

The sleep control module 202 receives the trigger signal and determines whether the current state (namely the second state) of the LCD 20 is “on” or “off”. If the second state is “off”, the sleep control module 202 transmits a sleep control instruction to the computer 30 via the data cable 230. The sleep detection module (not shown) of the computer 30 receives the sleep control instruction and controls the computer 30 to fall asleep. If the second state is “on”, the sleep control module 202 transmits a wake-up instruction to the computer 30 via the data cable 230. The sleep detection module of the computer 30 receives the wake-up instruction and wakes up the computer 30 from its sleep mode.

If the duration of pressing on the power switch 22 is not longer than the predetermined period of time, the microprocessor 21 only controls the LCD 20a to turn on or off.

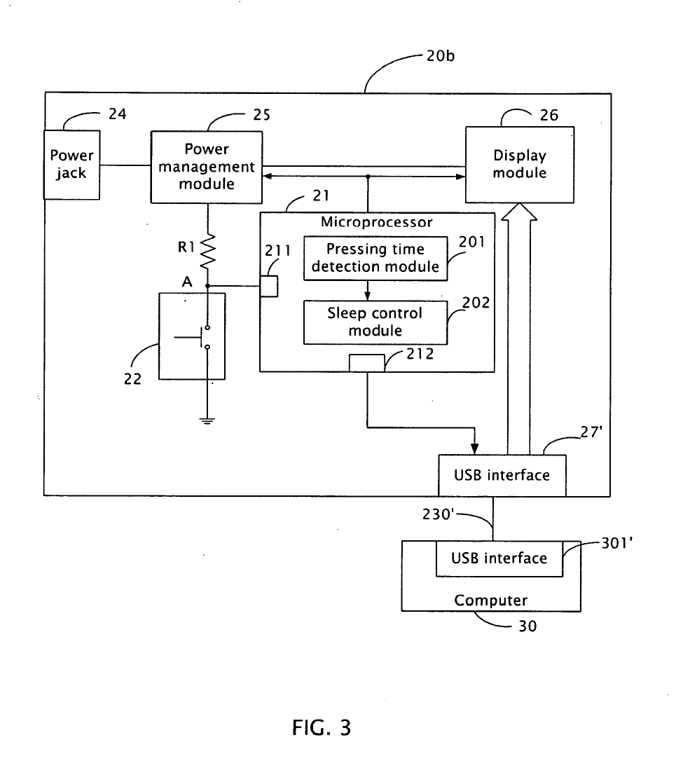

Referring also to FIG. 3, in a second embodiment, the display 20 is a LCD 20b. The serial bus interface 27 of the first embodiment is a USB interface 27′ in the present embodiment. The USB interface 27′ of the LCD 20b is configured to receive display signals from the computer 30 and transmit the sleep control instruction and the wake-up instruction to the computer 30. The USB interface 27′ is also configured for connecting to a USB interface 301′ of the computer 30 via a USB data cable 230′. When the pressing time detection module 201 determines the duration of pressing on the power switch 22 is longer than the predetermined period of time, the sleep control module 202 transmits the sleep control instruction or the wake-up instruction to the computer 30 via the USB data cable 230′, and correspondingly controls the computer 30 to fall asleep or to wake-up from its sleep mode.

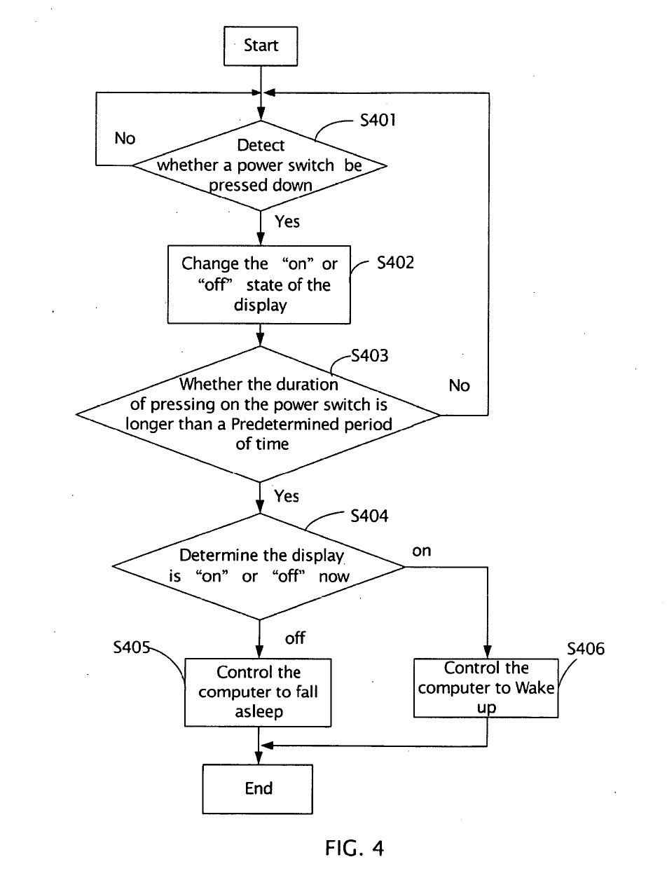

FIG. 4 is a flowchart illustrating a method for controlling a computer to fall asleep in accordance with another exemplary embodiment of the present invention. In step S401, the microprocessor 21 detects whether the power switch 22 has been pressed down, namely, determines whether a signal port 211 of the microprocessor 21 receives a pressing signal.

If the power switch 22 has been pressed down by the user, in step S402, the microprocessor 21 changes the state of the LCD 20a (or 20b ) from the first state to the second state. Namely, if the first state of the LCD 20a is “on”, the second state is “off” and the microprocessor 21 controls the LCD 20a to shut down. If the first state is “off” and the second state is “on”, the microprocessor 21 controls the LCD 20a to turn on.

In step S403, the pressing time detection module 201 determines whether the duration of pressing on the power switch 22 is longer than a predetermined period of time.

If the duration is longer than the predetermined period of time, in step S404, the pressing time detection module 201 transmits a trigger signal to the sleep control module 202, and the sleep control module 202 detects whether the second state of the LCD 20a is “on” or “off”.

If the second state of the LCD 20a is “off”, in step S405, the sleep control module 202 transmits a sleep control instruction to the computer 30 and controls the computer 30 to fall asleep.

If the second state of the LCD 20a is “on”, in step S406, the sleep control module 202 transmits a wake-up instruction to the computer 30 and wakes up the computer 30 from its sleep mode.

It is believed that the present embodiments and their advantages will be understood from the foregoing description, and it will be apparent that various changes may be made thereto without departing from the spirit and scope of the invention or sacrificing all of its material advantages, the examples hereinbefore described merely being exemplary embodiments of the present invention.

What is claimed is:

1. A display, comprising:
a serial bus interface configured for connecting the display to a computer;
a power switch configured for producing a pressing signal when being pressed down; and
a microprocessor configured for receiving the pressing signal, changing current state and controlling the display to turn on or off;
wherein the microprocessor comprises:
a pressing time detection module configured for determining a duration of pressing on the power switch and outputting a trigger signal when the duration is longer than a predetermined period of time; and
a sleep control module configured for receiving the trigger signal, determining a current state of the display, and transmitting a sleep control instruction to the computer via the serial bus interface to control the computer to fall asleep when the current state of the display is “off” and transmitting a wake-up instruction to the computer via the serial bus interface to wake up the computer from the sleep when the current state of the display is “on”.

2. The display of claim 1, wherein the serial bus interface is a universal serial bus (USB) interface or an IEEE 1 394 interface.

3. The display of claim 1, further comprising a display interface configured for receiving display signals from the computer.

4. The display of claimed 3, wherein the display interface is a video graphics array, a digital video interface or a USB interface.

5. The display of claim 1, wherein the serial bus interface is a USB interface, which is further configured for receiving display signals from the computer.

6. The display of claim 1, wherein the display is a liquid crystal display.

7. A method for controlling a computer to fall asleep, the method comprising:
detecting a pressing signal produced by pressing a power switch;
changing a current state of a display from a first state to a second state according to the pressing signal, wherein the first state is one of an “on” state or an “off” state of the display, and the second state is the other state;
determining whether a duration of pressing on the power switch longer than a predetermined period of time;
determining the second state of the display if the duration is longer than the predetermined period of time; and
controlling the computer to fall asleep if the second state of the display is “off”.

8. The method of claim 7, wherein the method further comprising:
waking up the computer if the second state of the display is the “on” state.

9. A computer system, the computer system comprising:
a display, comprising:
a serial bus interface configured for connecting the display to a computer;
a power switch configured for producing a pressing signal when being pressed; and
a microprocessor configured for receiving the pressing signal, changing current state and controlling the display to turn on or off; and comprising:
a pressing time detection module configured for determining a duration of pressing on the power switch and outputting a trigger signal when the duration of is longer than a predetermined period of time; and
a sleep control module configured for receiving the trigger signal and determining a current state of the display, transmitting a sleep control instruction to the computer via the serial bus interface to control the computer to fall asleep when the current state of the display is “off” and transmitting a wake-up instruction to the computer via the serial bus interface to wake up the computer when the current state of the display is “on”; and
a computer part comprising:
a serial bus interface configured for connecting with the serial bus interface of the display; and
a sleep detection module configured for detecting the sleep control instruction and the wake-up instruction, and controlling the computer fall asleep according to the sleep control instruction and waking up the computer according to the wake-up instruction.
